(19) United States
(12) Patent Application Publication
(10) Pub. No.: US 2008/0169636 A1
(43) Pub. Date: Jul. 17, 2008

(54) MUD FLAP

(75) Inventor: Hyungjin J. LEE, Edmonton (CA)

Correspondence Address: DAVIS BUJOLD & Daniels, P.L.L.C., 112 PLEASANT STREET, CONCORD, NH, 03301, US

(73) Assignee: EZ TRADING CORP., Seoul (KR)

(21) Appl. No.: 11/954,442

(22) Filed: Dec. 12, 2007

(30) Foreign Application Priority Data
Jan. 12, 2007 (CA) 2574073

(51) Int. Cl. B62D 25/18

(52) U.S. Cl. 280/851

(57) ABSTRACT

A mud flap includes a moulded body having a first face, a second face and a recess on the first face. A metallic plate is positioned in the recess of the moulded body. The plate has a peripheral edge with apertures positioned adjacent to the peripheral edge. The plate is secured in position within the recess by overlying lips with integral rivets that extend through the apertures; the overlying lips and integral rivets being part of the moulded body.

### FIELD

The present invention relates to mud flap.

### BACKGROUND

Canadian Patent 2,406,439(Cicansky) discloses a mud flap with a stainless steel plate incorporated into a pocket and secured against removal by stainless steel rivets.

### SUMMARY

There is provided a mud flap which includes a moulded body having a first face, a second face and a recess on the first face. A metallic plate is positioned in the recess of the moulded body. The plate has a peripheral edge with apertures positioned adjacent to the peripheral edge. The plate is secured in position within the recess by overlying lips with integral rivets that extend through the apertures; the overlying lips and integral rivets being part of the moulded body.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein;

FIG. 1 is a front elevation view of a mud flap;

FIG. 2 is a rear elevation view of the mud flap illustrated in FIG. 1; and

FIG. 3 is a side elevation view of the mud flap illustrated in FIG. 1.

### DETAILED DESCRIPTION

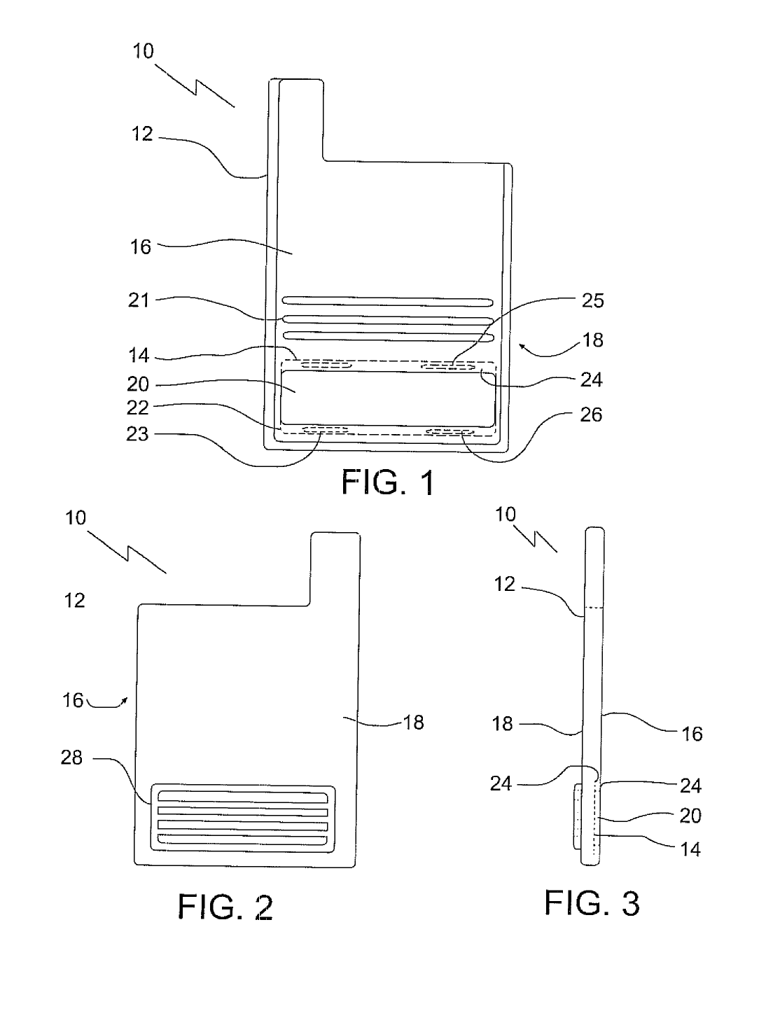

The preferred embodiment, a mud flap generally identified by reference numeral 10, will now be described with reference to FIG. 1-3.

Structure and Relationship of Parts:

FIG. 1 describes a mud flap 10 consisting of a moulded body 12 and a metallic plate 14. Moulded body 12 has a first face 16, and a second face 18. Moulded body 12 is made out of rubber. Alternatively, moulded body 12 may be made out of other suitable materials, such as polymer plastic. First face 16 has a recess 20, and integrated ribs 21. Plate 14, which is preferably of stainless steel, is positioned within recess 20. Plate 14 having a peripheral edge 22. Plate 14 may be made of other suitable materials. Apertures 23 are positioned adjacent to peripheral edge 22. Apertures 23 may be shaped as elongated slots 25, as shown. Alternatively, apertures 24 may be other suitable shapes, such as circles or squares. Plate 14 is secured in position within recess 20 by overlying lips 24, as shown in FIG. 3. Referring to FIG. 1, overlying lips 24 have integral rivets 26 that extend through apertures 24. Overlying lips 24 and integral rivets 26 are part of moulded body 12. The embodiment shown in FIGS. 1 and 3 shows overlying lips 24 as completely covering peripheral edge 22, but overlying lips 24 may alternatively cover only part of peripheral edge 22. FIG. 2 shows second face 18 of mud flap 10. Positioned on second face 18 is an integrated splash guard 28.

Operation:

Mud flap 10 is secured behind the wheel (not shown) of a vehicle for normal operation. Second face 18 faces the wheel, and splash guard 28 prevents any debris from the road from being kicked up by the wheel. Alternatively, first face 16 may face the wheel. Typical debris may include snow, ice, water, dirt, stones, rocks, or garbage. Stainless steel plate 14 provides an aesthetically appealing “mirrored” appearance and also serves to provide some degree of structural support.

Advantages:

In the prior art, metallic plates were attached by metal rivets. This was not aesthetically appealing and there was always a risk one or more of the metal rivets would fail. With mud flap 10, plate 14 is moulded into moulded body 12, with materially extending through apertures 24 serving as integrally formed rivets. This makes mud flap 10 more aesthetically appealing, as no rivets are visible. It also provides for increased strength.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

What is claimed is:

1. A mud flap, comprising:
a moulded body having a first face, a second face and a recess on the first face;
a metallic plate positioned in the recess of the moulded body, the plate having a peripheral edge with apertures positioned adjacent to the peripheral edge;
the plate being secured in position within the recess by overlying lips with integral rivets that extend through the apertures, the overlying lips and integral rivets being part of the moulded body.

2. The mud flap of claim 1, the moulded body being one of rubber or polymer plastic.

3. The mud flap of claim 1, the apertures being elongated slots.
